(19) United States
(12) Patent Application Publication
(10) Pub. No.: US 2026/0094437 A1
(43) Pub. Date: Apr. 2, 2026

(54) SYSTEMS AND METHODS FOR TASK PROGRESS ESTIMATION USING A GENERATIVE MODEL WITH SHUFFLED VIDEO INPUTS

(71) Applicant: GDM Holding LLC, Mountain View, CA (US)

(72) Inventors: Yecheng Ma, Mountain View, CA (US); Danny Michael Driess, San Francisco, CA (US); Wenhao Yu, Mountain View, CA (US); Sean Kirmani, San Francisco, CA (US); Ted Xiao, San Francisco, CA (US); Tingnan Zhang, San Jose, CA (US); Fei Xia, Menlo Park, CA (US); Qiao Liang, Santa Clara, CA (US); Dorsa Sadigh, Palo Alto, CA (US)

(21) Appl. No.: 19/342,059

(22) Filed: Sep. 26, 2025

Related U.S. Application Data
(60) Provisional application No. 63/702,037, filed on Oct. 1, 2024.

(51) Int. Cl. G06V 20/40; G06T 11/00

(52) U.S. Cl. CPC G06V 20/41; G06T 11/00

(57) ABSTRACT

Systems and methods are provided for generating task progress values from digital video. A temporal sequence of frames of a digital video is shuffled to generate a shuffled plurality of video frames. A reordering input prompt is assembled to include data indicative of one or more tasks depicted being performed in the digital video and the shuffled plurality of video frames. The reordering input prompt is processed using a generative model to generate data indicative of one or more task progress values corresponding to one or more of the shuffled plurality of video frames. Each task progress value represents an amount of progress towards accomplishing the one or more tasks that is depicted in the corresponding video frame. The generated task progress values may be used for various purposes, such as training a separate model, including a robot control policy, or for data quality control.

### BACKGROUND

Estimating visual and/or task progress in videos is a fundamental part of embodied intelligence that interacts with the visual world. For example, a robot agent capable of generalizable progress estimation can, in principle, learn new visuomotor skills and adapt them to new visual scenes. Yet, general purpose value learning, particularly in visual progress, remains a challenge. An effective machine learning model needs strong semantic, spatial, and temporal understanding that enables the semantic concept of “task progress”—e.g., a measure or quantification of an amount of progress towards completion of a task-to be grounded in the space-time manifold captured in a video. Existing value learning methods and models are trained on limited data with often the single modality of vision, preventing broad generalization to unseen scenes and new tasks described in language.

While machine learning models can be trained to estimate task progress from video, such training often involves significant quantities of labeled data. For example, some approaches involve training reward or value functions using human-provided videos. These methods may be trained on datasets that are limited in scope or that primarily feature a single modality, such as vision-only data. This can constrain the resulting model's ability to generalize to new or unseen tasks, different visual scenes, or tasks described using other modalities, such as natural language.

Other approaches to value learning may reason over individual frames of a video. Analyzing a single frame in isolation can introduce uncertainty, particularly in environments that are only partially observed from that frame's perspective. This uncertainty can lead to inconsistent predictions of task progress when analyzing a sequence of frames from a single video, especially over long-horizon tasks.

Some existing systems, such as certain vision-language models (VLMs), may be prompted to analyze video sequences to predict task progress. However, when presented with a chronological sequence of video frames, these models can exhibit a temporal bias. The chronological ordering of the frames itself can act as a strong signal, causing the model to generate monotonically increasing progress values without sufficient regard for the actual content of the frames or the quality of the task execution depicted. This can result in outputs that do not faithfully represent the actual progress toward completing a specified task. Consequently, there remains a need for methods to generate reliable task progress estimations from video data.

### SUMMARY

Disclosed are systems and methods for generating task progress values for video frames. The disclosed technologies address challenges in automatically estimating task progress from video, particularly the temporal biases that can arise when processing chronologically ordered video frames. The objective is to provide a robust and generalizable approach for value estimation that can be applied to various downstream machine learning applications, including data filtering, quality control, and the training of control policies for robots or other agents.

Consider a degenerate video formed by concatenating random, unrelated frames. Its frame order cannot be predicted when the frames are presented in shuffled order because the original order is no more natural than the shuffled ones. On the other hand, real videos, such as robot demonstrations, impose a natural temporal order that can be predicted-that is, some valid, asymmetric ordering of frames that makes the video visually and physically plausible. With implementations described herein, a variety of different VLMs can directly perform this task to satisfactory performance, uncovering task progress in each frame of the video.

In some implementations, the VLM may be prompted with a “reordering” prompt that includes, for instance, data indicative of task(s) being performed in a digital video (e.g., natural language task description or goal image(s)), the initial video frame, and one or more frames of the shuffled sequence of all frames of the video as inputs. The VLM may be used to process this data to generate, frame-by-shuffled-frame, a task progress value for each shuffled frame. This may be accomplished autoregressively (e.g., one task progress value generated per iteration of the model, with the previous task progress value(s) being included in subsequent input prompts) or as a single iteration where all task progress values are generated at once. The following demonstrates one example of how a reordering prompt might be formulated:

```
You are an expert roboticist tasked to predict task completion percentages
  for frames of a robot for the task of {task_description}. The task
  completion percentages are between 0 and 100, where 100
  corresponds to full task completion. We provide several examples of
  the robot performing the task at various stages and their
  corresponding task completion percentages. Note that these frames
  are in random order, so please pay attention to the individual frames
  when reasoning about task completion percentage.
We provide an example goal image of the task; in this image, the task
  completion percentage is 100. Goal image: {goal_image.png}
Initial robot scene: {initial_scene.png}
In the initial robot scene, the task completion percentage is 0.
Completion robot scene:
In the completion robot scene, the task completion percentage is 100.
{prompt hint}. Now, for the task of {task_description}, output the task
  completion percentage for the following frames that are presented in
  random order. For each frame, format your response as follows:
  Frame {i}: Task Completion Percentages :{ }%
Frame {i}:
```

In some implementations, techniques described herein may be applied autoregressively as follows. A first reordering prompt may be assembled to include all the frames of the digital video in shuffled order, a task description and/or goal image, the first frame of the unshuffled video, and an instruction to generate the progress value for the first frame in the shuffled sequence. The first reordering prompt conditions the generative model (e.g., VLM) to output the task progress value for the first frame in the shuffled sequence.

A second reordering prompt is then assembled to include, once again, the frames of the video in shuffled order, the task description and/or or goal image, and the first frame in the unshuffled video. However, unlike the first reordering prompt, the second reordering promt may be further assembled to include the previous model output (in this case the progress value for the first frame in the shuffled sequence) and an instruction to generate the progress value for the second frame in the shuffled sequence. The second reordering prompt conditions the VLM to output the task progress value for the second frame in the shuffled sequence. This may repeat until a full sequence of task progress values are generated corresponding to all frames of the shuffled digital video.

In various implementations, techniques described herein may frame value prediction as a visual question answering (VQA) problem in which a VLM is prompted to generate output indicative of the task progress for a batch of shuffled trajectory (e.g., video) frames. For example, given an expert trajectory such as an input video τ=(o₁, o₂, . . . , o_{T}), some implementations described herein first scramble the trajectory (e.g., frames of a video) in random temporal order and cause the shuffled trajectory to be processed using a VLM to make batched value predictions. For example, the VLM may autoregressively output respective task progress values v_{\tilde{1}}, . . . , v_{\tilde{T}} of the frames in the shuffled input order. This may be represented by the following equation:

$${v}_{\tilde{1}} , … , {v}_{\tilde{T}} = VLM ( {o}_{\tilde{1}} , … , {o}_{\tilde{T}} ; {l}_{task} ) \qquad ( 1 )$$

where (\tilde{1}, . . . , \tilde{T}) is a random shuffling of the trajectory's original sequence, (1, . . . , T) and lₜₐₛₖ is the task description (e.g., in natural language). In addition to or instead of the task description, in some implementations, a goal image i_{goal} may be used instead, e.g., in accordance with the following equation:

$${v}_{\tilde{1}} , … , {v}_{\tilde{T}} = VLM ( {o}_{\tilde{1}} , … , {o}_{\tilde{T}} ; {i}_{goal} ) \qquad ( 2 )$$

Given the above equations, for each individual task progress value prediction corresponding to each shuffled portion of the trajectory (e.g., video frame), the input-output relationship can be expressed as follows:

$${v}_{\tilde{t}} = VLM ( {o}_{\tilde{1}} , … , {o}_{\tilde{T}} ; {v}_{\tilde{1}} , … , {v}_{\tilde{t} - 1} , {l}_{task} ) , ∀ t ∈ [ 2 \cdot T ] \qquad ( 3 )$$

From equation (3) it can be seen that when outputting the task progress values v for later input frames, the VLM has already generated the task progress values for previous input frames. The previous frames' task progress values may be assembled into input prompts/the context window for a next task value prediction. This conditions the VLM to use previous predictions to inform a suitable value for the current observation σ_{\tilde{t}}, without having to be explicitly trained like classical, feed-forward value functions that learn to enforce self-consistency via value iteration. Put another way, using batch input and/or autoregressive prediction may condition the VLM to emulate self-consistent task progress value generation for observations within the same trajectory (e.g., within the same sequence of video frames).

It has been observed that when the VLM is used to process a sequence of video frames in its original chronological order, the VLM tends to generate monotonically increasing task progress values, ignoring the task description or the actual quality of the trajectory. Because VLMs are trained on chronologically ordered video frames on related tasks such as video captioning and video question answering, the chronology itself may be a cue for downstream task(s). This would likely overshadow any training instances involving batched value prediction, which is unlikely to be in the training set. Consequently, the output generated using the VLM includes unfaithful and/or low-quality task progress value predictions. However, by randomly shuffling the input frames, techniques described herein can break free of such temporal bias and force the VLM to evaluate each individual frame, so that the VLM's output includes faithful value predictions using all information provided in the input prompt/context.

Parameterizing value functions using autoregressive VLMs as described herein provides various technical benefits. It may enable flexible and versatile in-context value learning, by which value predictions can steadily improve by providing examples at test time without any VLM fine-tuning. It is possible to prepend shuffled videos and their ground-truth task progress values as in-context examples to boost the value prediction quality via few-shot learning, e.g., in accordance with the following:

$${v}_{\tilde{1}} , … , {v}_{\tilde{T}} = VLM ( {o}_{\tilde{1}} , … , {o}_{\tilde{T}} , {l}_{task} \vert shuffle ( ( {o}_{1} , {v}_{1} ) , ( {o}_{2} , {v}_{2} ) , … , ( {o}_{M} , {v}_{M} ) ) ) \qquad ( 4 )$$

Using these techniques, it is possible to condition the VLM on diverse categories of in-context examples, including videos of robots performing tasks.

If all input frames are shuffled, then the arrow of time from the original unshuffled video becomes ambiguous. In many cases, the reverse video is also physically plausible, making what is the ground-truth order difficult for even a well-trained model. Accordingly, in various implementations, the VLM may be conditioned using the first input frame of the video, allowing the VLM to anchor on this initial observation to better predict the values for all other shuffled video frames, e.g., in accordance with the following:

$${v}_{\tilde{1}} , … , {v}_{\tilde{T}} = VLM ( {o}_{\tilde{1}} , … , {o}_{\tilde{T}} , {l}_{task} , {o}_{1} ) , where \qquad ( 5 )$$

$$( \tilde{1} , … , \tilde{T} ) = shuffle ( 1 , … , T )$$

The normalized task progress values or measures may comprise a universal, task-agnostic notion of value. Accordingly, given an expert trajectory such as an input video τ=(o₁, o₂, . . . , o_{T}), a value function can be defined as

$$V ( {o}_{t} ) = \frac{t}{T} .$$

The VLM may then be prompted or conditioned to output integer-valued percentage numbers between 0 and 100. In addition, given that real-world robot video datasets are of typically different lengths and captured at different frequencies, all videos may be subsampled so that there are some predetermined number of frames in the input sequence to ensure comparable findings across datasets.

Generative model(s) described herein may take various forms, including, but not limited to, model(s) such as Gemini, Flamingo, PaLM, BERT, LaMDA, Meena, and/or any other single-modal or multimodal generative model, such as any other generative model that is encoder-only based, decoder-only based, sequence-to-sequence based and that optionally includes an attention mechanism or other memory, diffusion model(s), etc. Generative models may have hundreds of millions, or even hundreds of billions of parameters. In some implementations, generative models may include multi-modal models such as a VLM and/or a visual question answering (VQA) model, which can have any of the aforementioned architectures, and which can be used to process multiple modalities of data, particularly images and text, and/or images and audio for example, to generate one or more modalities of output.

The implementations described herein for predicting task progress values using shuffled trajectories (e.g., video frames) may be used for a variety of downstream use cases, many which have the flavor of using task progress values predicted as described herein for data quality control at the dataset, trajectory, and transition levels. For instance, techniques described herein may be used as a success detection mechanism/process to enable filtered behavior cloning on mixed quality datasets, and/or to enable controlling of a robot during inference based on success detection (or lack thereof). Task progress values predicted as described herein also may be used for advantage weighted regression on near-optimal teleoperation data. Task progress values generated using techniques described herein may also be used for purposes such as camera viewpoint diagnosis (e.g., determine whether a video is captured from a perspective suitable to learn embodied agent behavior), filtering training data (e.g., filtering from robot datasets videos that depict robots behaving sub optimally), and so forth.

Another downstream use case may be to train a robot control policy, e.g., by finetuning a VLM/multimodal model for robotic control, and/or to train a diffusion model such as any of the robot control policies described in “Visuomotor Policy Learning via Action Diffusion” (arXiv:2303.04137). Yet another downstream use case includes improving text-to-video or “video generation” models, such as denoising diffusion probabilistic models (DDPMs) (as described in “Denoising Diffusion Probabilistic Models” (arXiv:2006.11239)), Veo, etc. For example, the same or similar quality score or measure that is used to filter videos from training data may also be used, for instance, as a reward signal for training a video generation model. In one aspect, a method involves shuffling a temporal sequence of frames from a digital video to produce a shuffled plurality of video frames. A reordering input prompt is assembled from data indicating one or more tasks depicted in the video and the shuffled plurality of video frames. This prompt is processed using a generative model, such as a vision-language model, to generate one or more task progress values. Each task progress value corresponds to a frame from the shuffled plurality of video frames and represents a measure of progress toward accomplishing the one or more depicted tasks. The generated task progress values can be used for various purposes, such as training or finetuning a separate model, for instance, a robot control policy or a video generation model.

Implementations disclosed herein can mitigate (e.g., eliminate) various drawbacks with current techniques. For example, by shuffling the temporal sequence of frames from a digital video and processing the shuffled frames with a generative model, the temporal bias that can arise when processing chronologically ordered frames may be overcome, conditioning the model to evaluate frames based on content rather than sequential position. As another example, by processing the entire shuffled sequence of frames, rather than individual frames in isolation, the generative model can produce a more globally consistent set of task progress values, which reduces uncertainty that can result from analyzing a frame from a single, partially observed perspective. As another example, by using a large generative model, such as a vision-language model, to process multimodal inputs (e.g., video frames and natural language task descriptions), the resulting task progress estimations can be generalized to a broader range of unseen tasks and scenes compared to models trained on limited, single-modality datasets.

In another aspect, a method involves using a generative model to generate a sequence of task progress values for a corresponding sequence of video frames, where the frames are provided to the model in a shuffled temporal order. The task progress values may be generated autoregressively. A quality score for the sequence of video frames is then determined based on a correlation between the generated sequence of task progress values and the original temporal order of the video frames. Based on this quality score, the sequence of video frames can be selectively included in a training dataset for a separate model.

In yet another aspect, a system includes one or more processors and memory configured to perform these methods. The system can provide a shuffled sequence of video frames and a task indication as input to a generative model. The system uses the generative model to generate a sequence of task progress values, determines a quality score for the video based on a correlation between the task progress values and the original frame order, and classifies the video as suitable or unsuitable for training a separate model based on the quality score. This classification enables automated data curation and quality control for machine learning datasets.

### BRIEF DESCRIPTION OF THE DRAWINGS

FIG. 1 is a schematic diagram illustrating components of a system for generating task progress values for video frames.

FIG. 2 is an illustration of a robot that can be controlled using aspects of the disclosed technologies.

FIG. 3 is a conceptual diagram illustrating a process for generating task progress values from a shuffled sequence of video frames.

FIG. 4 is a flowchart illustrating a method for training a separate model using task progress values generated from shuffled video frames.

FIG. 5 is a flowchart illustrating a method for selectively including a sequence of video frames in a training dataset.

FIG. 6 is a block diagram illustrating an example computing device that can be used to implement aspects of the disclosed technologies.

### DETAILED DESCRIPTION

Various implementations described herein relate to generating task progress values from a digital video by processing a shuffled sequence of the video's frames. A temporal sequence of frames from a digital video is shuffled to generate a shuffled plurality of video frames. A reordering input prompt is then assembled using data indicative of one or more tasks depicted in the digital video, along with the shuffled plurality of video frames. The data indicative of the tasks can include, for example, a natural language description of the one or more tasks or one or more goal images that depict a completed state of the one or more tasks.

This reordering input prompt may be processed by a generative model, such as a vision-language model (VLM), to generate data indicative of one or more task progress values. Each task progress value may correspond to one of the shuffled video frames and represents an amount of progress towards accomplishing the one or more tasks depicted in that frame. By shuffling the input frames, the generative model may be conditioned to evaluate each frame based on its visual content in relation to the specified task, rather than relying on its original temporal position. This approach overcomes temporal biases that can cause models to generate monotonically increasing progress values for any chronological video, regardless of the quality of task execution. The resulting task progress values can provide a more globally consistent and faithful representation of task completion.

The generated task progress values can be utilized in various downstream applications. For instance, the values can serve as training data for a separate model, such as a robot control policy or a diffusion policy. The system can assign a quality score to the digital video based on a correlation between the generated task progress values and the original temporal order of the frames. Based on this quality score, the video may be classified as suitable or unsuitable for machine learning training, enabling automated curation of high-quality training datasets. This data filtering can lead to more effective and robust machine learning models.

For example, in a robotics context, a digital video might depict a robotic arm performing a task, such as folding a shirt. The frames of this video are shuffled and provided to a generative model along with a natural language description, for instance, “fold the dress shirt.” The model generates a task progress value for each shuffled frame, such as 0% for a frame showing the shirt completely unfolded and 100% for a frame where the fold is complete. These values can then be used to finetune a robot control policy for the robotic arm. Furthermore, a collection of such demonstration videos can be evaluated, and those videos showing a logical and successful progression of the task (as determined by their quality scores) may be used to train the control policy, thereby improving the robot's ability to perform the folding task successfully.

Similarly, in an autonomous vehicle context, a synthetic video could depict a self-driving car executing a complex maneuver, such as a three-point turn on a narrow street. The frames from this video may be shuffled and provided to a generative model with a task description like “complete a three-point turn.” The model would then generate task progress values for each frame, potentially assigning low values to frames showing the initial position and high values to frames showing the completed turn. A sequence of videos could be evaluated based on their assigned quality scores, and only those videos depicting successful and efficient maneuvers might be selected. These filtered videos and their corresponding progress values could then be used to finetune a control policy for the autonomous vehicle, improving its ability to navigate complex driving scenarios safely and effectively.

In some implementations, task value estimation may be framed as an autoregressive next-token prediction problem in which a vision-language model (VLM) is tasked with outputting a task progress for a batch of shuffled trajectory frames. Robotics tasks may be modeled as goal-conditioned partially observed Markov decision processes. Such a process may be defined by an observation space, an action space, a reward function, a transition function, a task horizon, an initial state distribution, and a goal space that specifies the task semantically. Conditioned on a task, an agent may aim to maximize its value function, or the expected cumulative reward over the task horizon.

For robotics applications, a universal, task-agnostic notion of value may be utilized, such as normalized task progress. This type of temporal value function may map an observation and a goal specification to a real number, for example, between 0 and 1, where initial observations of an environment may have a value of 0 and goal-satisfying observations may have a value of 1. Under such a definition, an expert trajectory may be described by a value function where the value is a function of the time step divided by the total number of time steps. A temporal value function may be learned that can predict such task progress for various real-world robotic tasks.

Given an input video, value estimates may be produced for each frame of the video. To make a VLM amenable to value prediction, several components may be utilized, including, for example: 1) autoregressive value prediction, 2) input observation shuffling, and 3) in-context value learning.

Regarding autoregressive value prediction, value functions such as V(⋅): [symbol] →R may be trained to be self-consistent by enforcing a Bellman equation such as the following:

$${V}^{π} ( {o}_{t} ) = R ( {o}_{t} ) + {𝔼}_{π , p} [ V ( {o}_{t + 1} ) ] .$$

When a value function is parameterized as a feed-forward neural network, this may be accomplished by minimizing the mean-squared error of the equality. Because values for different observations within the same trajectory are related via the Bellman equation, the resulting value function may remain consistent even if queried with only a single observation. VLMs, however, are not inherently trained with a consistency objective. Thus, if a VLM is independently queried with different observations from the same trajectory, it is likely to produce inconsistent values. By providing an entire trajectory as input instead of a single observation, a VLM may be provided a greater opportunity to generate self-consistent value estimates. For a given language description of a task, a VLM may be prompted to auto-regressively generate values given an entire video as context, e.g., in accordance with the following:

$${v}_{t} = VLM ( {o}_{1} , … , {o}_{T} ; {v}_{1} , … , {v}_{t - 1} ; {l}_{task} ) , ∀ t [ 2 , T ] .$$

For example, a value at a given time step may be a function of the VLM processing all observations from the beginning of the trajectory to the end, all previously generated values, and the language description of the task. This process allows the VLM to attend to all previous predictions and frames when making a next value prediction, enabling it to produce globally consistent estimates over long-horizon sequences.

Regarding input observation shuffling, it has been observed that when presented with a chronological sequence of frames, a VLM may discover a short-cut solution of outputting monotonically increasing values, often ignoring the task description or an actual quality of the trajectory. To break this temporal bias, input frames may be randomly shuffled. This may force the VLM to pay attention to each individual frame and output faithful value predictions using all information provided in context. In some implementations, a VLM may be prompted as follows:

$${v}_{\tilde{1}} , … , {v}_{\tilde{T}} = VLM ( {o}_{\tilde{1}} , … , {o}_{\tilde{T}} ; {l}_{task} , {o}_{1} ) , where$$

$$( \tilde{1} , … , \tilde{T} ) = permute ( 1 , … , T ) .$$

The permutation operator may randomly shuffle the temporal indices. It may be noted that not every frame is shuffled. If all frames are shuffled, an arrow of time in an original video may become ambiguous. The VLM may be conditioned on a first input frame, allowing it to use the first observation as an anchor point for all other shuffled frames.

Regarding in-context value learning, GVP performance may be further improved by leveraging properties of VLMs, such as in-context learning, where tasks may be learned by providing examples. This may enable flexible and versatile in-context value learning, by which predictions can steadily improve by providing examples at test time without any model fine-tuning. For example, shuffled videos and their ground-truth task progress may be prepended as in-context examples to boost value prediction quality via few-shot learning, e.g., as follows:

$${v}_{\tilde{1}} , … , {v}_{\tilde{T}} = VLM ( {o}_{\tilde{1}} , … , {o}_{\tilde{T}} , {l}_{task} \vert permute ( ( {o}_{1} , {v}_{1} ) , ( {o}_{2} , {v}_{2} ) , … , ( {o}_{M} , {v}_{M} ) ) )$$

A sequence of values may be generated by a VLM as a function of a set of shuffled observations and a task description, conditioned on a permuted set of example observations and their corresponding ground-truth values. For practical implementation, to predict temporal value functions, a VLM may be prompted to output integer-valued percentage numbers between 0 and 100. Given that real-world robot video datasets may have different lengths and may be captured at different frequencies, all videos may be subsampled so that there is a predetermined number of frames in an input sequence to ensure comparable findings across datasets.

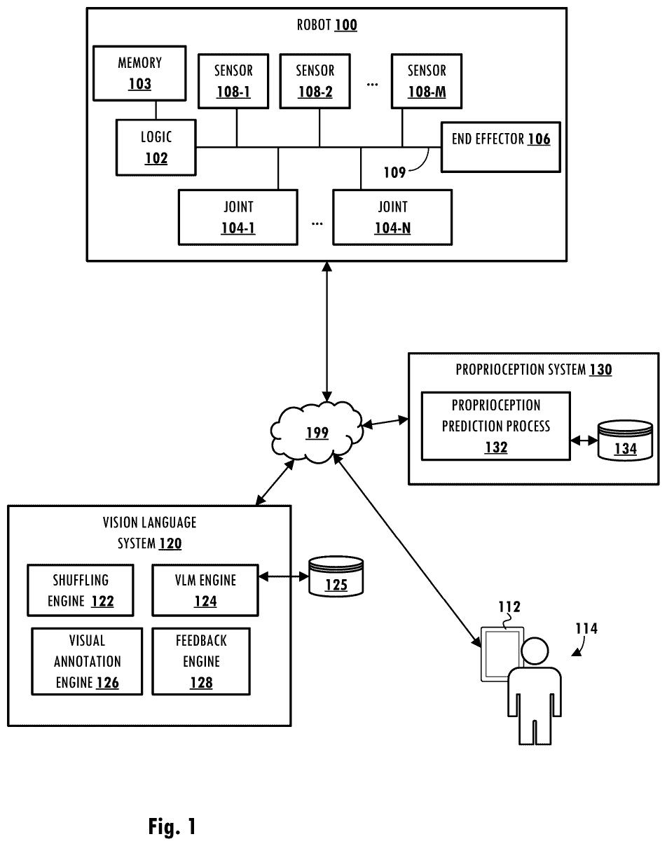

FIG. 1 is a schematic diagram of components that can cooperate to carry out selected aspects of the present disclosure, in accordance with various implementations. The various components depicted in FIG. 1, particularly those components forming a vision language system 120 and a proprioception system 130, may be implemented using any combination of hardware and software. The components of FIG. 1 are depicted as being communicatively coupled with each other via one or more networks 199, which may include one or more personal area networks, local area networks, and/or wide area networks (e.g., the Internet). However, this is not meant to be limiting. Various aspects of the present disclosure that are described as being performed by and/or stored on systems 120 and/or 130 can alternatively be performed by and/or stored on a single system, such as vision language system 120, or on any combinations of systems 120 and 130.

In some implementations, techniques described herein may be used to control various types of machines or apparatus. For example, in some implementations, a robot 100 may be in communication with systems 120 and/or 130. In various implementations, and/or all or parts of systems 120 and/or 130 may be implemented onboard robot 100. Other types of machines or apparatus that are not depicted in FIG. 1 may also be controlled using selected aspects of the present disclosure, such as autonomous vehicles, industrial equipment, climate control systems, medical systems and/or devices, video games, and so forth.

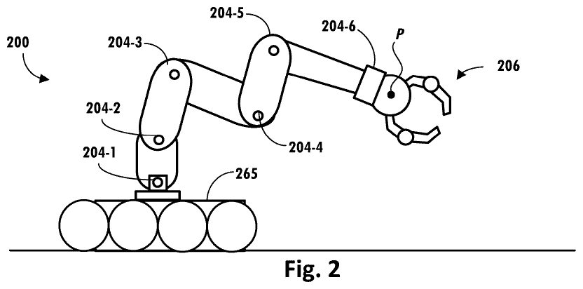

Robot 100 may take various forms, including but not limited to a telepresence robot (e.g., which may be as simple as a wheeled vehicle equipped with a display and a camera), a robot arm, a multi-pedal robot such as a “robot dog,” an aquatic robot, a wheeled device, a submersible vehicle, an unmanned aerial vehicle (“UAV”), and so forth. One non-limiting example of a mobile robot arm is depicted in FIG. 2. In various implementations, robot 100 may include logic 102. Logic 102 may take various forms, such as a real time controller, one or more processors, one or more field-programmable gate arrays (“FPGA”), one or more application-specific integrated circuits (“ASIC”), and so forth. In some implementations, logic 102 may be operably coupled with memory 103. Memory 103 may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, a robot controller may include, for instance, logic 102 and memory 103 of robot 100.

In some implementations, logic 102 may be operably coupled with one or more joints 104-1 to 104-N, one or more end effectors 106, and/or one or more sensors 108-1 to 108-M, e.g., via one or more buses 109. As used herein, a “joint” 104 of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. Some joints 104 may be independently controllable, although this is not required. In some instances, the more joints robot 100 has, the more degrees of freedom of movement it may have.

As used herein, an “end effector” 106 may refer to a variety of tools that may be operated by robot 100 in order to accomplish various tasks. For example, some robots may be equipped with an end effector 106 that takes the form of a claw with two opposing “fingers” or “digits.” Such a claw is one type of “gripper” known as an “impactive” gripper. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up an object). More generally, other types of end effectors may include but are not limited to drills, brushes, force-torque sensors, cutting tools, deburring tools, welding torches, containers, trays, and so forth. In some implementations, end effector 106 may be removable, and various types of modular end effectors may be installed onto robot 100, depending on the circumstances. Some robots, such as some telepresence robots, may not be equipped with end effectors. Instead, some telepresence robots may include displays to render visual representations of the users controlling the telepresence robots, as well as speakers and/or microphones that facilitate the telepresence robot “acting” like the user.

Sensors 108-1 to 108-M may take various forms, including but not limited to 3D laser scanners (e.g., light detection and ranging, or “LIDAR”) or other 3D vision sensors (e.g., stereographic cameras used to perform stereo visual odometry) configured to provide depth measurements, two-dimensional cameras (e.g., RGB, infrared), light sensors (e.g., passive infrared), force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth. While sensors 108-1 to 108-M are depicted as being integral with robot 100, this is not meant to be limiting.

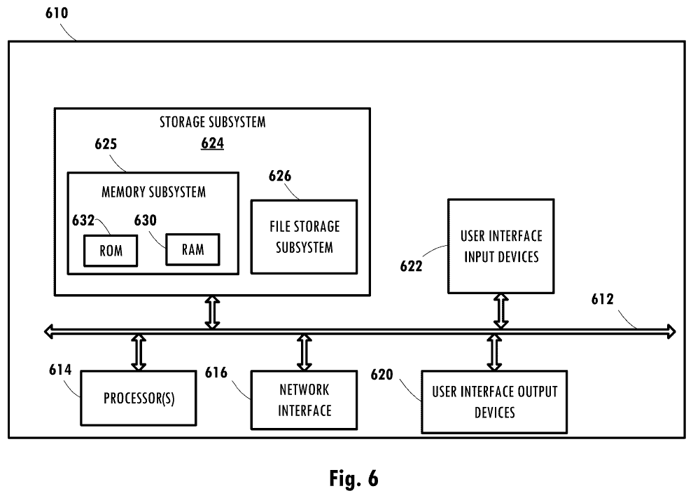

In some implementations, vision language system 120 and/or proprioception system 130 may include one or more computing devices cooperating to perform selected aspects of the present disclosure. An example of such a computing device is depicted schematically in FIG. 6. In some implementations, one or more of systems 120 and/or 130 may include one or more servers forming part of what is often referred to as a “cloud” infrastructure, or simply “the cloud.” Alternatively, one or more components of systems 120 and/or 130 may be operated by logic 102 of robot 100.

Machine learning model(s) described herein may take various forms, including, but not limited to, generative language model(s) (sometimes referred to as “large language models,” or “LLMs”) such as PaLM, BERT, LaMDA, Meena, Gemini, and/or any other generative language model, such as any other generative model that is encoder-only based, decoder-only based, sequence-to-sequence based and that optionally includes an attention mechanism or other memory. In generative model form, machine learning model(s) may have hundreds of millions, or even hundreds of billions of parameters. In some implementations, machine learning model(s) may include a multi-modal model such as a VLM and/or a visual question answering (VQA) model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few.

Vision language system 120 may include a shuffling engine 122, a VLM engine 124, one or more VLMs 125, a video evaluation engine 126, and a feedback engine 128. Any of engines 122, 124, 126, and/or 128 may be implemented using any combination of hardware and software. Moreover, any of engines 122, 124, 126, and/or 128 may be combined with other(s) of engines 122, 124, 126, and/or 128.

In various implementations, shuffling engine 122 may be configured to shuffle a temporal sequence of frames of a digital video to generate a shuffled plurality of video frames. VLM engine 124 may be configured to use one or more VLMs 125 to process the shuffled sequences of video frames to generate progress scores, such as task progress values for one or more of the shuffled frames. Each task progress value may represent an amount of progress towards accomplishing a task that is depicted in the corresponding video frame.

Video evaluation engine 126 may be configured to perform various operations based on the progress scores. For example, video evaluation engine 126 may assign a quality score to a digital video based on the progress scores. In some implementations, video evaluation engine 126 may classify a digital video as suitable or unsuitable for machine learning training based on the progress scores. The quality score and/or classification may be used to conditionally train or finetune a separate model, such as a robot control policy or a video generation model.

Feedback engine 128 may be configured to obtain user feedback. The user feedback may be provided by a human user, e.g., via a user interface, and may be used to adjust the operation of VLM engine 124 or video evaluation engine 126. In some implementations, feedback engine 128 may obtain the user feedback in response to a request, e.g., via a user interface. In other implementations, feedback engine 128 may obtain the user feedback via an API.

Proprioception system 130 may be present in some implementations where robot 100 is being controlled using techniques described herein, e.g., where vision language system 120 is not capable of directly generating robot control data, but instead generates intermediate data (e.g., a plan that includes a sequence of actions) that is then processed by proprioception system 130 to obtain output usable to control robot 100, e.g., control signals for individual joints 104-1 to 104-N and/or end effector(s) 106. Proprioception system 130 may be omitted in other circumstances, such as when vision language system 120 is capable of directly generating robot control data. Proprioception system 130 may include a proprioception prediction process 132 and one or more proprioception machine learning models 134. An example of a proprioception machine learning model that may be used is described in “RT-1: Robotics Transformer for Real-World Control at Scale” (arXiv:2212.06817).

In various implementations, proprioception prediction process 132 may process input tokens indicative of a current (or past) proprioception values of robot 100, e.g., along with other data such as data indicative of a task or action to be performed (e.g., an action sampled and selected as described herein), state data of the robot's environment, etc., to generate robot control data and/or predict future proprioception values of robot 100. These robot control data and/or future proprioception values may be used to operate robot 100. “Robot control data” may include, for instance, low-level actuator commands (also referred to as “joint commands,” and may include torque commands) that directly control the actuators/joints 104-1 to 104-N of the robot, cartesian commands that specify direction(s) for an end effector 106, a target robot pose, code that specifies reward functions that a motion controller can optimize (e.g., using techniques such as receding horizon optimization) to find optimal low-level actuator commands, selected predefined robot primitives, and so forth. In some cases, robot logic 102 may be configured to convert between joint commands and Cartesian commands, e.g., using forward and/or inverse kinematics.

In various implementations, a user 112 may control robot 100 using a client device 114. While depicted as a tablet computer or smart phone in FIG. 1, client device 114 may take other forms, such as a desktop or laptop computer, in-vehicle computing device, augmented reality (AR) and/or virtual reality (VR) headset or glasses, standalone “smart” speakers that host automated assistants that can be interacted with to control robot 100, etc. In various implementations, user 112 may issue one or more natural language commands, e.g., by typing the commands or uttering the commands aloud and having those spoken utterances transcribed using speech-to-text (STT) processing. These natural language commands may specify a task to be completed by robot 100 in an environment in which robot 100 operates. For example, user 112 may ask robot 100 to “pick up the helix-shaped dog chew toy,” “close the windows,” “take the dishes from the table to the sink,” etc.

FIG. 2 depicts a non-limiting example of a robot 200 in the form of a robot arm. An end effector 206 in the form of a gripper claw is removably attached to a sixth joint 204-6 of robot 200. In this example, six joints 204-1 to 204-6 are indicated. However, this is not meant to be limiting, and robots may have any number of joints. In some implementations, robot 200 may be mobile, e.g., by virtue of a wheeled base 255 or other locomotive mechanism. Robot 200 is depicted in FIG. 2 in a particular selected configuration or “pose.”

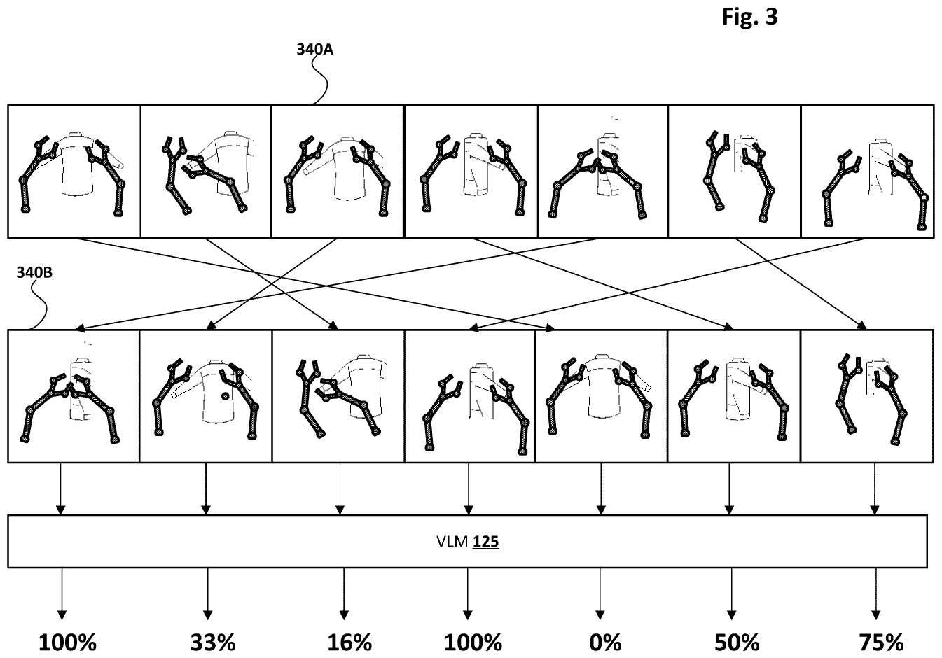

FIG. 3 schematically depicts aspects of the present disclosure, in accordance with various implementations. An original temporal sequence of frames 340A, which may form part of a digital video, shows a robot 100 performing a task. In this example, the task is folding a dress shirt. The sequence of frames 340A begins at left with the shirt unfolded and progresses until the shirt is folded in the right-most frame.

Shuffling engine 122 may be configured to shuffle the temporal sequence of frames 340A to generate a shuffled plurality of video frames 340B. As illustrated by the arrows in FIG. 3, the original chronological order of the frames is altered in the shuffled plurality of video frames 340B.

VLM engine 124 may then process the shuffled plurality of video frames 340B. For example, a reordering input prompt may be assembled, the prompt including data indicative of one or more tasks depicted being performed in the digital video (e.g., “fold the dress shirt”) and the shuffled plurality of video frames 340B. This reordering input prompt may be processed using a generative model, such as VLM 125, to generate data indicative of one or more task progress values corresponding to one or more of the shuffled plurality of video frames. In the depicted example, each of the seven frames in the shuffled sequence 340B is processed to generate a corresponding task progress value, where each task progress value represents an amount of progress towards accomplishing the shirt folding task. For instance, the frame depicting the completely unfolded shirt is assigned a task progress value of 0%, while frames depicting a completed fold are assigned a value of 100%.

Video evaluation engine 126 may use these task progress values to evaluate the quality of the original temporal sequence of frames 340A. For example, a quality score can be assigned to the digital video based on a correlation between the sequence of task progress values and the original temporal order of the sequence of video frames 340A. A high correlation may indicate that the video depicts a logical and successful progression of the task.

This quality score can be used for various downstream purposes. For instance, the digital video can be classified as suitable or unsuitable for machine learning training. If a plurality of digital videos are classified, a separate model, such as a robot control policy for robot 100, may be trained or finetuned based on the respective sequences of task progress values associated with only the digital videos classified as suitable for machine learning training. In this manner, the quality of training data can be automatically curated, potentially leading to more effective robot control policies. The task progress values may also be used in robotic planning, for instance, by serving as a reward signal or value function to guide a robot 100 in completing a task.

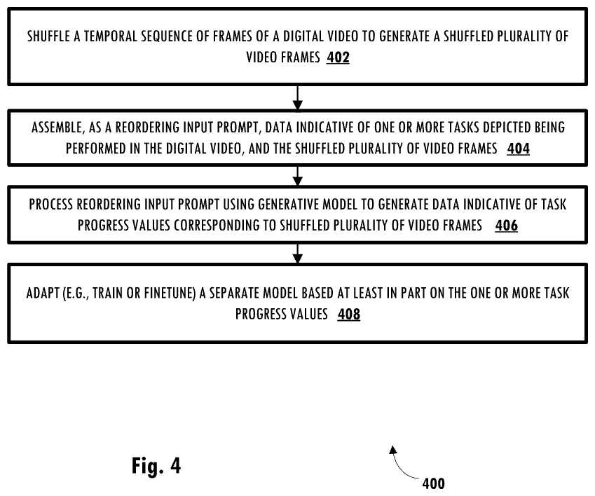

FIG. 4 is a flowchart depicting a method 400 for practicing selected operations of the present disclosure. For convenience, the operations of method 400 will be described as being performed by a system, such as vision language system 120 of FIG. 1, configured with selected aspects of the present disclosure. It should be appreciated that various operations of method 400 may be added, split into multiple operations, omitted, reordered, combined with other operations, and so forth.

At block 402, the system may shuffle a temporal sequence of frames of a digital video to generate a shuffled plurality of video frames. In some examples, shuffling engine 122 of vision language system 120 may be configured to perform this operation. The digital video may depict a real or simulated robot, such as robot 100, performing one or more tasks. In other instances, the digital video may be a synthetic digital video generated using a video generation model, for instance, by processing a natural language snippet that describes one or more of the tasks.

At block 404, the system may assemble, as a reordering input prompt, data indicative of one or more tasks depicted being performed in the digital video, and the shuffled plurality of video frames. In some implementations, VLM engine 124 may assemble the reordering input prompt. The data indicative of the one or more tasks may include one or more natural language descriptions of the tasks. For instance, the system may process the digital video using a vision-language model to generate the one or more natural language descriptions. The data indicative of the tasks may also include one or more goal images depicting one or more of the tasks having been completed. In some examples, the reordering input prompt is further assembled to include one or more demonstration digital videos. Frames of these demonstration digital videos may also be randomly shuffled and may be labeled with their corresponding original temporal positions. The reordering input prompt may also include a request to reorder the shuffled plurality of video frames into the original temporal sequence of frames.

At block 406, the system may process the reordering input prompt using a generative model to generate data indicative of one or more task progress values corresponding to one or more of the shuffled plurality of video frames, wherein each task progress value represents an amount of progress towards accomplishing one or more of the tasks that is depicted in the corresponding video frame. In various examples, VLM engine 124 may be configured to process the prompt using one or more VLMs 125. The generative model may be or include a vision-language model that also generated the natural language descriptions of the tasks.

At block 408, the system may adapt (e.g., train or finetune) a separate model, such as a text-to-video model, based at least in part on the one or more task progress values. This separate model may be a generative model, such as a diffusion policy, a robot control policy, a pre-trained vision-language model (VLM), or a video generation model. For instance, a VLM may be finetuned using the one or more task progress values. The system may also assign a quality score to the digital video based on one or more of the task progress values. This quality score may be used to conditionally train the separate model. The system may also classify the digital video as suitable or unsuitable for machine learning training based on the task progress values, and may classify a plurality of digital videos in this manner. Training or finetuning of the separate model may then proceed based on task progress values associated only with videos classified as suitable, while refraining from using values from videos classified as unsuitable.

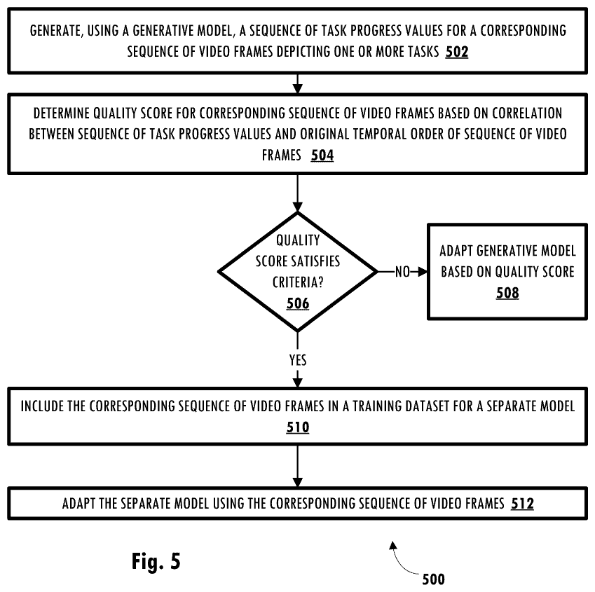

FIG. 5 is a flowchart depicting a method 500 for practicing selected operations of the present disclosure. For convenience, the operations of method 500 will be described as being performed by a system, such as vision language system 120 of FIG. 1, configured with selected aspects of the present disclosure. It should be appreciated that various operations of method 500 may be added, split into multiple operations, omitted, reordered, combined with other operations, and so forth.

At block 502, the system may generate, using a generative model, a sequence of task progress values for a corresponding sequence of video frames depicting one or more tasks. In various implementations, the sequence of video frames may provided as input to the generative model in a shuffled temporal order. Each task progress value in the sequence of task progress values may be generated autoregressively based on previously generated task progress values in the sequence. In some implementations, VLM engine 124 may perform this operation using one or more VLMs 125. The sequence of video frames may be part of a digital video, which shuffling engine 122 may have previously shuffled.

At block 504, the system may determine a quality score for the corresponding sequence of video frames based on a correlation between the sequence of task progress values and an original temporal order of the sequence of video frames. In some examples, video evaluation engine 126 may be configured to determine the quality score.

At block 506, the system may determine whether the quality score satisfies one or more criteria. For instance, the system may determine whether the quality score exceeds a quality threshold. As another example, the system may determine whether the quality score exceeds a prior quality score associated with a different sequence of video frames processed by the generative model. As yet another example, the system may determine whether the quality score is greater than a negative quality threshold.

If the answer at block 506 is no, then at block 508, the system may discard the sequence of video frames. However, if the answer at block 506 is yes, then at block 510, the system may selectively include the corresponding sequence of video frames in a training dataset for a separate model, such as a robot control policy, text-to-video model, etc. For instance, video evaluation engine 126 may classify the digital video as suitable or unsuitable for training a separate model based on the quality score. At block 512, the system may adapt (e.g., train, finetune, or otherwise) the separate model based on the corresponding sequence of video frames. In some implementations, the separate model may include a robot control policy, and the system may cause a robot, such as robot 100, to be operated based on the robot control policy.

In a further example, the operations depicted in FIG. 5 can be used to evaluate and improve a text-to-video model. A text-to-video model may be configured to generate synthetic digital videos based on natural language prompts. For instance, such a model could generate a video depicting “a person assembling a chair from a flat-pack kit” in response to receiving that text as input.

To evaluate the quality of the generated video, the system may, at block 502, process the sequence of frames from the synthetic video using a generative model to generate a sequence of task progress values. As described previously, this may involve shuffling the frames and providing them along with the task description (“assembling a chair”) to a VLM. At block 504, the system determines a quality score for the synthetic video based on the correlation between the generated task progress values and the video's original temporal frame order.

At block 506, the system determines whether the quality score satisfies a criterion, such as exceeding a quality threshold. A high quality score may indicate that the generated video depicts a logical and physically plausible progression of the chair assembly task. If the score meets the criterion (a “yes” at block 506), at block 510, the video and its corresponding task progress values may be selectively included in a training dataset. If not, the video may be discarded at block 508. This process can be repeated for numerous videos generated by the text-to-video model. At block 512, the text-to-video model is then adapted, for example by finetuning, using the high-quality videos and their task progress values selected at block 510. The task progress values could function as a reward signal, conditioning the model to generate videos that more accurately and coherently depict the progression of tasks described in input prompts.

FIG. 6 is a block diagram of an example computing device 610 that may optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods of FIGS. 4 and 5, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In some implementations, a method may be implemented using one or more processors. The method may include shuffling a temporal sequence of frames of a digital video to generate a shuffled plurality of video frames. The method may also include assembling, as a reordering input prompt, data indicative of one or more tasks depicted being performed in the digital video, and the shuffled plurality of video frames. The method may further include processing the reordering input prompt using a generative model to generate data indicative of one or more task progress values corresponding to one or more of the shuffled plurality of video frames. In certain implementations, each task progress value may represent an amount of progress towards accomplishing one or more of the tasks that is depicted in the corresponding video frame.

In various implementations, the method may further include training or finetuning a separate model based at least in part on the one or more task progress values. The separate model may include a generative model. For example, the separate model may include a diffusion policy, a robot control policy, a pre-trained vision-language model (VLM), or a video generation model. In implementations where the separate model includes a robot control policy, the method may further include causing a robot to be operated based on the robot control policy. In implementations where the separate model includes a VLM, the VLM may be finetuned using the one or more task progress values.

In some implementations, the method may further include assigning a quality score to the digital video based on one or more of the task progress values. The method may further include causing output to be rendered at one or more output devices, where the output conveys the quality score. In certain examples, the method may also include, based on the quality score, conditionally training a separate model using one or more of the task progress values. The digital video may be a synthetic digital video generated using a video generation model. In such cases, the method may further include processing a natural language snippet using the video generation model to generate the synthetic digital video. The natural language snippet may describe one or more of the tasks depicted being performed in the synthetic digital video.

In various implementations, the data indicative of the one or more tasks depicted being performed in the digital video may include one or more natural language descriptions of the one or more tasks depicted being performed in the video. The method may further include processing the digital video using a vision-language model to generate the one or more natural language descriptions. In some cases, the generative model may include the vision-language model. The data indicative of the one or more tasks depicted as being performed in the digital video may also include one or more goal images depicting one or more of the tasks having been completed.

In certain implementations, the reordering input prompt may be further assembled to include one or more demonstration digital videos. Frames of one or more of the demonstration digital videos may be randomly shuffled. The randomly shuffled frames may be labeled with corresponding original temporal positions in the demonstration digital video prior to the demonstration digital video being randomly shuffled. The reordering input prompt may further include a request to reorder the shuffled plurality of video frames into the original temporal sequence of frames.

In some examples, the video may depict a real or simulated robot performing the one or more tasks. The method may further include classifying the robot performance of the one or more tasks as a success or failure based on one or more of the task progress values. The method may also include causing a robot to be controlled based on the classification of the robot performance of the one or more tasks.

In various implementations, the method may further include classifying the digital video as unsuitable for machine learning training based on one or more of the task progress values corresponding to the shuffled plurality of video frames. The method may also include classifying a plurality of digital videos, including the digital video, as suitable or unsuitable for machine learning training based on respective sequences of task progress values generated for the plurality of digital videos. The method may further include training or finetuning a separate model based on respective sequences of task progress values associated with digital videos of the plurality of digital videos that were classified as suitable for machine learning training. In some cases, the method may include refraining from training or finetuning a separate model based on respective sequences of task progress values associated with digital videos of the plurality of digital videos that were classified as unsuitable for machine learning training. The separate model may include a robot control policy, and the method may further include controlling a robot using the robot control policy.

In another implementation, a method may be implemented using one or more processors. The method may include generating, using a generative model, a sequence of task progress values for a corresponding sequence of video frames depicting one or more tasks. The sequence of video frames may be provided as input to the generative model in a shuffled temporal order. Each task progress value in the sequence of task progress values may be generated autoregressively based on previously generated task progress values in the sequence. The method may further include determining a quality score for the corresponding sequence of video frames based on a correlation between the sequence of task progress values and an original temporal order of the sequence of video frames. The method may also include, based on the quality score, selectively including the corresponding sequence of video frames in a training dataset for a separate model.

In a further implementation, a method may be implemented using one or more processors. The method may include providing, as an input to a generative model, a shuffled sequence of video frames from a digital video and an indication of a task depicted in the digital video. The method may also include generating, using the generative model, a sequence of task progress values, where each task progress value in the sequence of task progress values corresponds to a respective video frame in the shuffled sequence of video frames. The method may further include determining a quality score for the digital video based on a correlation between the sequence of task progress values and an original temporal order of the sequence of video frames. The method may also include classifying the digital video as suitable or unsuitable for training a separate model based on the quality score.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
shuffling a temporal sequence of frames of a digital video to generate a shuffled plurality of video frames;
assembling, as a reordering input prompt, data indicative of:
one or more tasks depicted being performed in the digital video, and
the shuffled plurality of video frames, and
processing the reordering input prompt using a generative model to generate data indicative of a one or more task progress values corresponding to one or more of the shuffled plurality of video frames, wherein each task progress value represents an amount of progress towards accomplishing one or more of the tasks that is depicted in the corresponding video frame.

2. The method of claim 1, further comprising training or finetuning a separate model based at least in part on the one or more task progress values.

3. The method of claim 2, wherein the separate model comprises a generative model.

4. The method of claim 3, wherein the separate model comprises a diffusion policy.

5. The method of claim 3, wherein the separate model comprises a robot control policy.

6. The method of claim 5, further comprising causing a robot to be operated based on the robot control policy.

7. The method of claim 3, wherein the separate model comprises a pre-trained vision-language model (VLM).

8. The method of claim 7, wherein the VLM is finetuned using the one or more task progress values.

9. The method of claim 3, wherein the separate model comprises a video generation model.

10. The method of claim 1, further comprising assigning a quality score to the digital video based on one or more of the task progress values.

11. The method of claim 10, further comprising causing output to be rendered at one or more output devices, where the output conveys the quality score.

12. The method of claim 10, further comprising, based on the quality score, conditionally training a separate model using one or more of the task progress values.

13. The method of claim 10, wherein the digital video is a synthetic digital video generated using a video generation model.

14. The method of claim 13, further comprising processing a natural language snippet using the video generation model to generate the synthetic digital video, wherein the natural language snippet describes one or more of the tasks depicted being performed in the synthetic digital video.

15. The method of claim 1, wherein the data indicative of the one or more tasks depicted being performed in the digital video comprises one or more natural language descriptions of the one or more tasks depicted being performed in the video.

16. The method of claim 15, further comprising processing the digital video using a vision-language model to generate the one or more natural language descriptions.

17. The method of claim 16, wherein the generative model comprises the vision-language model.

18. The method of claim 1, wherein the reordering input prompt is further assembled to include one or more demonstration digital videos.

19. A method implemented using one or more processors and comprising:
generating, using a generative model, a sequence of task progress values for a corresponding sequence of video frames depicting one or more tasks, wherein the sequence of video frames is provided as input to the generative model in a shuffled temporal order, and wherein each task progress value in the sequence of task progress values is generated autoregressively based on previously generated task progress values in the sequence;
determining a quality score for the corresponding sequence of video frames based on a correlation between the sequence of task progress values and an original temporal order of the sequence of video frames; and
based on the quality score, selectively including the corresponding sequence of video frames in a training dataset for a separate model.

20. A method implemented using one or more processors and comprising:
providing, as an input to a generative model, a shuffled sequence of video frames from a digital video and an indication of a task depicted in the digital video;
generating, using the generative model, a sequence of task progress values, wherein each task progress value in the sequence of task progress values corresponds to a respective video frame in the shuffled sequence of video frames;
determining a quality score for the digital video based on a correlation between the sequence of task progress values and an original temporal order of the sequence of video frames; and
classifying the digital video as suitable or unsuitable for training a separate model based on the quality score.
